(19) United States
(12) Patent Application Publication
(10) Pub. No.: US 2023/0034564 A1
(43) Pub. Date: Feb. 2, 2023

(54) FOAMING COMPOSITION FOR HIDING EXCREMENT AND AVOIDING SPLASHES AND FALLING NOISES

(71) Applicant: CLEANEOR, Champigny-sur-Marne (FR)

(72) Inventor: Christian DANOS, Champigny sur Marne (FR)

(21) Appl. No.: 17/786,436

(22) PCT Filed: Dec. 18, 2019
(86) PCT No.: PCT/FR2019/053167

§ 371 Date: Jun. 16, 2022

(51) Int. Cl. C11D 17/06; C11D 3/00; C11D 3/10; C11D 3/20; C11D 3/12; C11D 17/04; C11D 11/00; C11D 1/14

(52) U.S. Cl. CPC C11D 17/06; C11D 3/0094; C11D 3/0068; C11D 3/10; C11D 3/2086; C11D 3/124; C11D 17/044; C11D 11/0058; C11D 11/0023; C11D 1/143

(57) ABSTRACT

A foaming composition containing a foaming agent that is made up of at least one acid and at least one base. The base and the acid being able to react in the presence of water, producing carbon dioxide. The composition also contains an anionic surfactant. The composition is in the form of a loose powder and in that it contains a mass percentage of the surfactant that is greater than or equal to 3% and is less than or equal to 4%. In particular, the mass percentage of the surfactant is less than 3.5%, and/or a mass percentage of the acid and base mixture is greater than or equal to 90%. The composition allows a foam to be obtained that allows excrement to be hidden, and splashes, rising odors and falling noises to be avoided.

The present invention relates to a foaming composition able to be dissolved in the water in toilet bowls.

When an excrement falls into the toilet bowl, a more or less loud noise occurs and splashes may emerge from the bowl. These drawbacks arise during urination and defecation.

In many countries and particularly in Japan, the fact that the excrement (urine and feces) falling into the water in the toilet bowl produces a noise perceptible to those around is poorly considered and considered to make both the user, the person using the toilets, and the persons around, uncomfortable.

The flush is frequently operated before use; the noise of the flush emptying or refilling being used to cover the noise produced by the urination or defecation. This method is expensive in terms of water and is to be avoided from an ecological point of view, the water in toilets generally being drinking water.

Toilet paper is frequently thrown into the bottom of the toilet bowl in order to avoid the noises of excrement (urine and feces) falling into the water as well as for avoiding splashes. This method is expensive in terms of paper and is to be avoided from an ecological point of view.

Other solutions to the aforementioned problems have therefore been sought.

### BACKGROUND OF THE INVENTION

The document CN102703230A describes a compressed powder in the form of a solid tablet, which, when it is put in the water in the toilets, forms a fairly dense foam for avoiding splashes. This foam is also deodorizing and anti-soiling. This composition is in the form of a powder and contains 21% or more by mass of an anionic surfactant. It contains, in addition to the surfactant, a foaming agent, a complexing agent, a foam stabilizer, a binder and a lubricant. The foaming agent is selected from sodium carbonate, calcium carbonate, sodium hydrogencarbonate (sodium bicarbonate or bicarbonate of soda), potassium carbonate, potassium hydrogencarbonate and at least one acid selected from tartaric acid, fumaric acid, adipic acid, citric acid and malic acid. The anionic surfactant may be a sulfonate of an alpha olefin, sodium lauryl sulfate, fatty acid polyoxyethylene ether sulfate (AES) or a sodium salt of an alkylbenzene sulfonate (LAS), in particular. The aforementioned document does not describe any specific composition. The complexing agent is selected from: EDTA, disodium EDTA, tetrasodium EDTA, EGTA, phenanthroline, triethanolamine, sodium tripolyphosphate, sodium pyrophosphate, sodium hexametaphosphate or sodium gluconate. Some of these chelating agents are also disinfectants. The stabilizer is selected from alkanolamides, polyacrylamides, polyvinyl alcohol, cetyl alcohol, cellulose, polypeptides, starch, alkyl glycoside (APG) and amine oxides. The binder is selected from carboxymethyl cellulose sodium salt (CMC-Na), hydroxypropyl methyl cellulose (HPMC), hydroxypropyl cellulose (L-HPC), microcrystalline cellulose, polyvinyl pyrrolidone (PVP), crosslinked polyvinyl pyrrolidone (PVPP), dextrin, absolute ethanol and polyethylene glycol. The lubricant is selected from salt, magnesium lauryl sulfate, magnesium stearate, L-leucine, sodium acetate, talc, fatty acid esters and sugar, sodium stearyl fumarate, sodium alginates, magnesium and aluminum silicates, and silica gel. The lubricant and the binder are used to form the solid tablet by compression of the powder but have a tendency to make the obtained foam heavier and therefore to impair its stability. The raw materials must be properly dried to ensure the absence of chemical reaction. The high surfactant content of this product makes its impact on the environment not insignificant. Moreover, the foam formed is especially useful for muffling the noises of urine in the toilet bowl. The foam is not sufficiently firm for cushioning the fall of feces.

The document JP2010/063503A describes a composition in powder form that contains 1 to 30 parts by mass of a stabilizer for foam. This document discloses a composition containing guar gum as a thickener, 3 g of sodium bicarbonate, 3 g of citric acid and egg white as a stabilizer.

The document JP2011/012410A describes a liquid agent for preventing urine splashes that contains a water-soluble polymer and having an average molecular weight in number of 1,000,000 to 8,000,000. This polymer may be sodium polyacrylate. The viscosity of the water in the toilet bowl being increased and the polymer forming a film on the surface of the water or of the porcelain, the noise is cushioned.

The document JP2015/052257A describes a composition in powder form that contains citric acid, an alkaline bicarbonate, a cationic or amphoteric surfactant, a viscosity agent and optionally a perfume. The surfactant cleans the toilets because of its lipophilic character.

The document JPH03-72124A describes a composition that includes citric acid, sodium carbonate and flocks of water-soluble fibers. This composition is laminated on water-soluble paper. When the whole dissolves in the water of the toilet bowl, the acid and the sodium carbonate react to produce carbon dioxide. The fibers increase the viscosity of the water so that a stable foam forms.

The document JPH06-105893A describes a composition containing a mixture of sodium carbonate, fumaric acid or succinic acid, a perfume and sodium lauryl ether sulfate. The mixture in powder form is compacted twice so that the surfactant is in a large quantity in the external layer of the solid thus formed. This method is tedious to implement.

The document JPH07-278598A describes a deodorizing and cleaning powder for cleaning the toilet bowl. This powder can be compacted in tablet form. It contains a foaming agent (1-80 parts by mass), a surfactant (1-80 parts by mass), a foam stabilizing agent (1-80 parts by mass) and a perfume or fragrance (1-80 parts by mass). The foaming agent contains a bicarbonate or a carbonate and an acid such as fumaric or succinic acid. The surfactant is selected from sulfates. The stabilizer is cellulose, a vinyl polymer or a fatty acid amide. The foam formed serves to clean the toilets but it is not sufficiently thick and copious to cushion the fall of urine or feces.

The document US2005/049154A1 describes an effervescent deodorizing solid. A powder containing sodium bicarbonate, citric acid and a perfume is compacted to form a solid. When this solid dissolves in the water in the toilets, it produces carbon dioxide and releases the perfume. There also, the foam produced cannot cushion the fall of excrement; it just cleans the toilet bowl by mechanical action when the bubbles form.

The document US2007/039089A1 describes a composition in the form of 2 mm to 10 mm in diameter grains and containing a bicarbonate, an acid that may be citric acid, a surfactant selected from sodium stearate, sodium dodecyl sulfate, cetalkonium chloride, lecithin, hydroxyl polyethoxydodecane, a surfactant modifier selected from glycerin, methyl soyate and cellulose. The perfume is selected from limonene and pinene, which are essential oils.

The document WO2008/020246A2 describes a solid tablet containing 30% by mass of sodium bicarbonate, 30-35% by mass of citric acid, 25-30% by mass of sodium dodecyl sulfate, 5% of cocamidopropyl betaine, less than 2% of perfume and an antibacterial agent. The large quantity of surfactant makes this product environmentally unfriendly.

The document WO2016/017829A1 does not give any concrete example but suggests mixing sodium bicarbonate, citric acid and a surfactant. This surfactant can be selected from: fatty acid salts, alkylbenzene sulfonates, alkylbenzene sulfonates, the alkyl being linear, laureth 4 and many other surfactants known per se. Whatever the case, the surfactant is in a proportion of 20% by mass of the acid-base-surfactant mixture, which makes the product non-ecological.

### Technical Problems Solved by the Invention

One aim of the present invention is to propose a foaming composition that, when it is dissolved in the water of the toilet bowl, quickly produces a layer of foam the thickness and density of which make it possible to cushion the urine and bowel movements.

Another aim of the present invention is to propose a composition as aforementioned, the foam of which re-forms quickly, once the excrement has fallen into the water of the bowl, in order to mask the excrement.

Another aim of the present invention is to propose a composition as aforementioned that can be stored at ambient temperature and ambient humidity for at least two months.

Another aim of the present invention is to propose a composition as aforementioned that is in the form of a loose powder and which does not form clumps even when it is stored for two months at ambient temperature and humidity.

Another aim of the present invention is to propose a composition as aforementioned, the ecological impact of which is low.

Another aim of the present invention is to propose a composition as aforementioned, wherein the layer of foam limits the rise of nauseating odors.

Another aim of the present invention is to propose a composition as aforementioned, the layer of foam of which limits noises when excrement is falling on the water.

Another aim of the present invention is to propose a composition as aforementioned, the layer of foam of which limits splashing when excrement falls onto the water.

### BRIEF SUMMARY OF THE INVENTION

To solve any one of the aforementioned drawbacks of the prior art, the present invention proposes a foaming composition comprising a foaming agent that comprises at least one acid and at least one base, said base and said acid being able to react in the presence of water by producing carbon dioxide, said composition also containing an anionic surfactant.

Characteristically, according to the invention, said composition is in the form of a loose powder and comprises a percentage by weight of the surfactant equal to or greater than 3% and equal to or less than 4% and in particular less than 3.5%, and/or a mass percentage of the acid/base mixture equal to or greater than 90%.

The quantity of surfactant being limited, the impact on the environment is also limited. The applicant has also shown that, surprisingly, such a quantity of surfactant is sufficient to obtain a stable foam for 5 minutes, which cushions the fall of excrement and which closes up again after the fall thereof so as to mask the excrement. In addition, a foam is obtained that forms very quickly and which forms a thick layer on the surface of the water in the toilets. In addition, the presence of the surfactant, even at this small percentage, provides to the composition of the invention, a cleaning effect.

According to the invention, the foaming agent is no way limited. It may comprise, for example, an acid selected from tartaric acid, fumaric acid, adipic acid, citric acid and malic acid, sulfamic acid and from the mixtures of two or more of these acids. It may also comprise at least one base selected from sodium carbonate, calcium carbonate, sodium hydrogencarbonate (sodium bicarbonate or bicarbonate of soda), potassium carbonate, potassium hydrogencarbonate and mixtures of two or more of these bases.

According to a particularly advantageous embodiment, said foaming agent consists of citric acid, sulfamic acid and sodium bicarbonate. Advantageously, the mass percentage of citric acid is greater than the mass percentage of sulfamic acid in order to reduce the impact on the environment, sulfamic acid being harmful for the aquatic environment. The kinetics of dissolution of citric acid and of sulfamic acid being different, the presence of these two acids makes it possible to obtain a foam that forms over a longer period than with a single acid. The bicarbonate reacting first with the H+ ions released by one of the acids and then with those released by the other, the period during which the foam forms is longer for the same quantity of foam formed.

The applicant has shown that this foaming agent makes it possible to reduce the quantity of surfactant, in particular when it is a case of a surfactant as defined below.

Advantageously, the sodium bicarbonate has a mean diameter less than or equal to 130 μm (measured according to the sieve method). Such a granulometry makes it possible to quickly obtain foam and a total and rapid dissolution of the composition of the invention.

Advantageously, the citric acid is in the form of particles having a mean diameter equal to or greater than 149 μm and equal to or less than 595 The sulfamic acid is in the form of particles having a mean diameter less than 2 mm. Such granulometries allow a good mixing of the compounds in powder form, which quickly procures a homogeneous foam.

Advantageously, the surfactant is selected from sodium salts of alkylbenzene sulfonates and in particular alkylbenzene sulfonates the alkyl chain of which is linear. The applicant showed that the combination of such a surfactant with a foaming agent as aforementioned proved to be effective in terms of foam (stability, cushioning, speed of obtaining) even with a small quantity of surfactant, thus reducing the impact of the composition of the invention on the environment. The aforementioned surfactants the alkyl of which is linear are more quickly degraded by the environment in the presence of oxygen.

Thus, advantageously, in particular when the surfactant is as aforementioned, the mass percentage of said surfactant is equal to or less than 1.5% and in particular equal to 1.2%.

Advantageously, the composition of the invention furthermore contains a thickener selected from gums, in particular guar gum, starch, pectin, agar agar, gelatin, carrageenans and alginates, in particular sodium alginates.

Sodium alginates will be preferred since they are soluble in the anionic surfactant. In this way good synergies are obtained between the surfactant, which forms a copious foam because of the release of CO₂ from the foaming agent, and the thickener, which makes it possible to preserve this foam over time and to increase the density thereof. In this way a better cushioning of the objects is obtained without any noise of falling in the water and a layer of foam that re-forms after the excrement passes.

Moreover, the alginate forms a protective film on the surface of the toilets when the foam forms. This film sets back the formation of scale on the surface of the toilet bowl.

According to a particular embodiment, which can be combined with all the aforementioned embodiments, the mass percentage of said thickener is substantially less than 2.00% and in particular equal to 1.60%. This percentage is fairly low so as to reduce the impact on the environment; it is nevertheless effective as previously disclosed. It makes it possible to obtain the aforementioned synergy with the anionic surfactant.

Advantageously, the composition of the invention furthermore contains silica in powder form. The silica makes it possible to absorb water and thus to store the composition of the invention for a longer time in the form of loose powder.

Advantageously, said silica has a specific surface measured in accordance with the BET method equal to or greater than 420 m²/g and in particular equal to 420 m²/g. Such a silica proves to be effective even in a small quantity. It avoids the powder of the invention agglomerating. Being in a small quantity, it does not interfere neither with the formation of foam nor with the stability thereof. The granulometry of the silica is advantageously equal to or greater than 35.0 μm and equal to or less than 65 μm. Such particles make it possible to absorb well the water in the powder. The silica particles are finer than the particles of the other components in order to mix well with the latter and to be inserted in the interstices formed by the particles of the other components, so as to absorb water effectively.

Advantageously, the mass percentage of said silica is between 0.08 and 0.3% and in particular equal to 0.26% or 0.51%. This percentage does not interfere with the formation and stability of the foam. It also does not increase the weight of composition to be used for obtaining a satisfactory effect in toilets.

The composition of the invention may comprise a perfume/fragrance. This is selected from synthetic perfumes and is not an essential oil. It may be selected from the perfumes comprising at least one of the following compounds: alpha-cetrene epoxide, bornyl acetate, 8-sec-butylquinoline, 2,4,6-triethylcyclohex-3-ene-1-carb aldehyde, decaline, dibutylamine, synthetic amber, 1,1-dimethoxy-2-phenyl propane, methyl isonicotinate, nootkatone, 1-octen-3-ol, isophorone (low and high concentration), isopropyl quinolone, argeol and gamma-undecalactone.

The present invention also relates to a water- and airtight flexible sachet, containing the composition according to the invention. This sachet is such that the composition in the form of a powder forms a layer less than 2 cm thick in order not to agglomerate under its own weight.

The sachet can advantageously contain from 20 g to 45 g of the composition of the invention, and in particular 38.90, 39.00 g or 39.20 g of the composition of the invention.

### EXPERIMENTAL RESULTS

### Examples of Composition According to the Invention

Seven examples of compositions according to the invention are given in tables 1 to 4 below. All these compositions are in the form of loose powder.

TABLE 1

| Composition no. | | 184-05 | | 184-48 | |
|---|---|---|---|---|---|
| Commercial name | Chemical name | Mass % | g/dose | Mass % | g/dose |
| Citric acid | Citric acid | 37.11 | 14.00 | 37.03 | 14.40 |
| Sulfamic acid | Sulfamic acid | 10.31 | 4.00 | 10.28 | 4 |
| Marlon Arl | Sodium alkylbenzene | 3.09 | 1.20 | 3.08 | 1.20 |
| | sulfonate | | | | |
| Sodium bicarbonate | Bicarbonate of soda | 45.36 | 17.60 | 45.24 | 17.60 |
| Algogel 3541 | Sodium alginate | 4.12 | 1.60 | 4.11 | 1.60 |
| Pine perfume | Clean pine A334587 | | | | |
| | (Ungerer Limited) | | | | |
| Marine perfume | Blue perfume A273797 | | | | |
| | (Ungerer Limited) | | | | |
| Sipernat 50 | Silica (BET = 450 m²/g) | | | 0.26 | 0.10 |
| Total | | 100 | 38.80 | 100 | 38.90 |

TABLE 2

| Composition no. | | 184-50 | | 184-51 | |
|---|---|---|---|---|---|
| Commercial name | Chemical name | Mass % | g/dose | Mass % | g/dose |
| Citric acid | Citric acid | 36.92 | 14.40 | 36.83 | 14.40 |
| Sulfamic acid | Sulfamic acid | 10.26 | 4.00 | 10.23 | 4 |
| Marlon Arl | Sodium alkylbenzene | 3.08 | 1.20 | 3.07 | 1.20 |
| | sulfonate | | | | |
| Sodium bicarbonate | Bicarbonate of soda | 45.13 | 17.60 | 45.01 | 17.60 |
| Algogel 3541 | Sodium alginate | 4.10 | 1.60 | 4.09 | 1.60 |
| Pine perfume | Clean pine A334587 | | | | |
| | (Ungerer Limited) | | | | |
| Marine perfume | Blue perfume A273797 | | | 0.51 | 0.20 |
| | (Ungerer Limited) | | | | |
| Sipernat 50 | Silica (BET = 450 m²/g) | 0.51 | 0.20 | 0.26 | 0.10 |
| Total | | 100 | 39.00 | 100 | 39.10 |

TABLE 3

| Composition no. | | 184-52 | | 184-53 | |
|---|---|---|---|---|---|
| Commercial name | Chemical name | Mass % | g/dose | Mass % | g/dose |
| Citric acid | Citric acid | 36.73 | 14.40 | 36.83 | 14.40 |
| Sulfamic acid | Sulfamic acid | 10.20 | 4.00 | 10.23 | 4 |
| Marlon Arl | Sodium alkylbenzene | 3.06 | 1.20 | 3.07 | 1.20 |
| | sulfonate | | | | |
| Sodium bicarbonate | Bicarbonate of soda | 44.90 | 17.60 | 45.01 | 17.60 |
| Algogel 3541 | Sodium alginate | 4.08 | 1.60 | 4.09 | 1.60 |
| Pine perfume | Clean pine A334587 | | | 0.51 | 0.20 |
| | (Ungerer Limited) | | | | |
| Marine perfume | Blue perfume A273797 | 0.51 | 0.20 | | |
| | (Ungerer Limited) | | | | |
| Sipernat 50 | Silica (BET = 450 m²/g) | 0.51 | 0.20 | 0.26 | 0.10 |
| Total | | 100 | 39.20 | 100 | 39.10 |

TABLE 4

| Composition no. | | 184-54 | |
|---|---|---|---|
| Commercial name | Chemical name | Mass % | g/dose |
| Citric acid | Citric acid | 36.74 | 14.40 |
| Sulfamic acid | Sulfamic acid | 10.20 | 4.00 |
| Marlon Arl | Sodium alkylbenzene | 3.06 | 1.20 |
| | sulfonate | | |
| Sodium bicarbonate | Bicarbonate of soda | 44.90 | 17.60 |
| Algogel 3541 | Sodium alginate | 4.08 | 1.60 |
| Pine perfume | Clean pine A334587 | 0.51 | 0.20 |
| | (Ungerer Limited) | | |
| Marine perfume | Blue perfume A273797 | | |
| | (Ungerer Limited) | | |
| Sipernat 50 | Silica (BET = 450 m²/g) | 0.51 | 0.20 |
| Total | | 100 | 39.20 |

Citric acid corresponds to the product sold by the company Quaron under the name citric acid ANH FIN GR E330. It has a mean granulometry (sieve method) of 149 μm (inclusive) to 595 μm (inclusive).

Sulfamic acid corresponds to the product sold by the company Brenntag under the name Sulfamic acid TS grade. It has a mean granulometry (sieve method) of less than 2 mm.

Bicarbonate of soda corresponds to the product sold by the company La Compagnie du Bicarbonate under the name sodium bicarbonate grade 1. It has a mean granulometry (sieve method) of less than or equal to 130 μm.

Alginate corresponds to the product sold by the company Unipex under the name Algogel 3541. It has a mean granulometry (sieve method) of less than 125 μm.

Silica corresponds to the product sold by the company Azelis under the name Sipernat 50. It has a mean granulometry (sieve method) of 35.0 to 65.0 μm (inclusive).

The specific surface of the silica was measured by the conventional BET method with nitrogen.

The fragrances are sold by Ungerer Limited. They are in the form of a colorless or light yellow liquid. These fragrances are synthetic; it is therefore not a case of essential oils.

Marlon is sold by the company Brenntag. It is in the form of a white powder.

The compositions are formed by simple mixing of the constituents without prior drying.

### Selection of Surfactant

The same compositions as those indicated in Tables 1 to 4 were tested with, in place of the sodium alkyl benzoate salt, a mixture of sodium lauryl sarcosinate, sodium cocoyl isethionate and sodium lauryl sulfate. After 15 days of storage of the powder at ambient temperature, the composition no longer formed any foam when it was dissolved in water.

### Experimental Protocol

A ready-to-install toilet CLEO WC, made from white ceramic, horizontal outlet, ref 647982, sold by Mr.Bricolage, was used for the tests. These toilets are not fixed. They can easily be manipulated.

The toilets, previously cleaned, are filled to the maximum with water (until the water stabilizes). The initial water level is marked and then, from this initial level, a centimeter scale up to 15 cm is affixed. The toilets are then filled with water (mains water of hardness 35° HF and 20° C.) up to the base mark.

The dose of composition to be tested was added and the level of foam was evaluated after: 30 sec, 1 min, 1 min 30, 2 min, 3 min and 4 min.

At the end of 5 minutes, 5 plugs (3×3 cm and 18.8 g) are dropped from the height of the toilet seat aimed at the centre, the top, the bottom, the right and the left. The following points are then noted: Is there any splashing of liquid? Is there a splash noise? Are the plugs visible? Does the foam close over the plugs? During the test all relevant remarks are also noted.

The results are as below for each of the compositions of the above tables stored for 15 days at 40° C. either in a cup or in a watertight and airtight welded aluminum sachet.

### Composition 184-05 (Reference Composition) Stored in a Cup

Height of foam at 30″: 9.5; 1′30: 9.5 cm; at 2′00: 9.5 cm; 2′30: 9 cm; 3′: 9 cm; 4′: 9 cm. The foam is aerated, noise is attenuated, the holes close up, the powder is not completely dissolved, there are no splashes, no plugs are seen.

### Composition 184-05 (Reference Composition) Stored in Aluminum Sachet

Height of foam at 30″: 9 cm; 1′30: 8.5 cm; at 2′00: 8.5 cm; 2′30: 8.5 cm; 3′: 8 cm; 4′: 7 cm. The foam is aerated, noise is attenuated, the holes close up, there are no splashes, no plugs are seen, the object is cushioned.

Composition 184-48 Stored in Sachet Height of foam at 30″: 9 cm; 1′30: 8.5 cm; at 2′00: 8.5 cm; 2′30: 8.5 cm; 3′: 8 cm; 4′: 7 cm. The foam is aerated, noise is attenuated, the holes close up, there are no splashes, no plugs are seen, the object is cushioned.

### Composition 184-50 Stored in Sachet

Height of foam at 30″: 9 cm; 1′30: 8.5 cm; at 2′00: 8.5 cm; 2′30: 8.5 cm; 3′: 8 cm; 4′: 7 cm. The foam is aerated, noise is attenuated, the holes close up, there are no splashes, no plugs are seen, the object is cushioned.

### Composition 184-51 Stored in Sachet

Height of foam at 30″: 8 cm; 1′30: 7.5 cm; at 2′00: 7 cm; 2′30: 6.5 cm; 3′: 6 cm; 4′: 5 cm. The foam is aerated, noise is attenuated, the holes close up, there are no splashes, no plugs are seen, the object is cushioned.

### Composition 184-52 Stored in Sachet

Height of foam at 30″: 9.5 cm; 1′30: 8.5 cm; at 2′00: 8 cm; 2′30: 7 cm; 3′: 6.5 cm; 4′: 5 cm. The foam is aerated, noise is attenuated, the holes close up, there are no splashes, no plugs are seen, the object is cushioned.

### Composition 184-53 Stored in Sachet

Height of foam at 30″: 7 cm; 1′30: 5.5 cm; at 2′00: 5 cm; 2′30: 5 cm; 3′: 4 cm; 4′: 3.5 cm. The foam is fragile, it does not close up after the fall, the cushioning is only slight, presence of noise.

Composition 184-54 Stored in Sachet Height of foam at 30″: 9 cm; 1′30: 8.5 cm; at 2′00: 8 cm; 2′30: 7.5 cm; 3′: 7 cm; 4′: 5.5 cm. The foam is aerated, noise is attenuated, the holes close up, there are no splashes, no plugs are seen, the object is cushioned.

### Selection of Silica

A silica having a BET of 120 m²/g was tested. The results on the agglomeration of the powder after 2 months are less good than with silica having a specific surface measured in accordance with the BET method of 450 m²/g. The silica tends to make the foam heavy and to break the bubbles because of its presence in solid form therein. The finer the silica (indicate numerical values) the more stable the foam remains once formed.

### Influence of the Proportion of Silica

Two proportions of silica were studied, namely at 0.26%, i.e., 0.10 g, and 0.51%, i.e., 0.20 g. The performances in toilets in terms of height of foam, cushioning and behavior of the foam in a fall and after the fall of objects are not affected. On the other hand, the silica has an influence on performance after storage and on the agglomeration of the powder.

### Influence of Storage Time on the Performance in Toilets

The same experiments as above were implemented with each of the compositions after 15 days at 40° C. (storage in closed oven) and one month of storage at ambient temperature (average humidity) and after 15 days at 40° C. and 2 months at ambient temperature (ditto as for 1 month). The sign C indicates that the composition was stored in a cup while the sign S indicates that the composition was stored in a sachet.

Table 5 contains the results for 15 days at 40° C. and then 1 month of storage at ambient temperature under the aforementioned humidity conditions.

Table 6 contains the results for 15 days at 40° C. (storage in closed oven) and then 2 months of storage at ambient temperature under the aforementioned humidity conditions. The foam height is measured in cm.

In all the results of the present application without figures, only the alterations that impair the use or storage of the product are noted. If no alteration is noted with regard to the composition, this does not appear in the results.

TABLE 5

| Composition | 184-05 | 184-48 | 184-50 | 184-51 | 184-52 | 184-53 | 184-54 |
|---|---|---|---|---|---|---|---|
| Height of foam | (C )6 | (S) 10 | (S) 11 | (S) 8.5/ | (S) 8.5/ | (S) 10.5/ | (S) 11/9 |
| at 30″ | | | | 8 (C) | 6 (C) | 9 (C) | (C) |
| Height of foam | (C) 7.5 | (S) 9.5 | (S) 10.5 | (S) 7.5/ | (S) 8/6 (C) | (S) 9.5/ | (S) 10/ |
| at 1′30 | | | | 7.5 (C) | | 8.5 (C) | 8 (C) |
| Height of foam | (C) 7.5 | (S) 9 | (S) 10 | (S) 6.5/ | (S) 7.5/ | (S) 9 | (S) 9/7.5 |
| at 2′ | | | | 7 (C) | 5.5 (C) | 8 (C) | (C) |
| Height of foam | (C) 8/ | (S) 9 | (S) 9.5 | (S) 6.5/ | (S) 7/5 (C) | (S) 8/ | (S) 8.5/ |
| at 2′30 | | | | 7 (C) | | 7.5 (C) | 7 (C) |
| Height of foam | (C) 8/ | (S) 9 | (S) 9 | (S) 6/ | (S) 6/ | (S) 7.5/7 (C) | (S) 8/7 (C) |
| at 3′ | | | | 6.5 (C) | 5 (C) | | |
| Height of foam | (C) 8/ | (S) 8 | (S) 8.5 | (S) 4/5 (C) | (S) 5/4 (C) | (S) 6/7(C) | (S) 7/5.5 (C) |
| at 4′ | | | | | | | |

TABLE 6

| Composition | 184-05 | 184-48 | 184-50 | 184-51 | 184-52 | 184-53 | 184-54 |
|---|---|---|---|---|---|---|---|
| Height of foam | (C) 6 | (S) 10 | (S) 10 | (S) 9/8.5 (C) | (S) 10.5/4 (C) | (S) 9/6 | (S) 10/9 |
| at 30″ | | | | | | (C) | (C) |
| Height of foam | (C) 7 | (S) 10 | (S) 10 | (S) 7/7.5 (C) | (S) 8.5/ | (S) 8/6 | (S) 8.5/ |
| at 1′30 | | | | | 3.5 (C) | (C) | 8.5 (C) |
| Height of foam | (C) 7 | (S) 10 | (S) 9.5 | (S) 4.5/7 (C) | (S) 7.5/ | (S) 7.5/ | (S) 7.5/8 |
| at 2′ | | | | | 3.5 (C) | 5.5 (C) | (C) |
| Height of foam | (C) 7 | (S) 9.5 | (S) 9.5 | (S) 6/6 (C) | (S) 6/3 (C) | (S) 6.5/5 | (S) 7/8 |
| at 2′30 | | | | | | (C) | (C) |
| Height of foam | (C) 7 | (S) 9 | (S) 9 | (S) 5/6 (C) | (S) 5/3 (C) | (S) 6/5 | (S) 6/7.5 |
| at 3′ | | | | | | (C) | (C) |
| Height of foam | (C) 7 | (S) 8.5 | (S) 8.5 | (S) 4/5 (C) | (S) 3.5/3 (C) | (S) 5/4.5 | (S) 5/7 |
| at 4′ | | | | | | (C) | (C) |

Results after 15 Days of Storage at 40° C.

The composition 184-51 forms a foam but the cushioning is less good and slight splashing is noted (powder stored in cup). The same applies with the composition 184-52 stored in a cup. For the composition 184-53 stored in a cup, the performance is not altered. If it is stored in an aluminum sachet, the cushioning is weaker and the foam obtained is fragile, it does not close up after the fall of the plugs. No alteration is noted for the composition 184-54 stored in a sachet. On the other hand, when it is stored in a cup, little foam and very little cushioning is obtained.

Results after One Month of Storage

The composition 184-51 stored in a cup cushions less than after 15 days. The same applies with the composition 184-52, which in addition causes a few splashes. For the other compositions, the performance is stable and identical to that obtained after 15 days at 40° C.

Results after Two Months of Storage

The composition 184-51 stored in a cup cushions less well. The same applies with the composition 184-52 which, in addition, causes greater splashing and does not attenuate noise. For the other compositions, the performance is stable and identical to that obtained after 15 days at 40° C. It is even found that, for the compositions 184-48, 184-50 and 184-54, the height of foam obtained is greater than that obtained after 15 days at 40° C., which is surprising.

### Influence of the Container on the Agglomeration of the Powder

After 15 days at 40° C., the sachet containing the composition 184-48 is swollen, indicating a chemical reaction in the sachet and therefore a release of CO₂. The same applies with the compositions 184-51 and 184-52, the powder of which is greatly agglomerated in the sachet, which is also swollen. The sachet containing the composition 184-53 is a little swollen but the composition remains in the form of a loose powder (without any clump formed).

After one month, the composition 184-48 has formed a block but the sachet is little swollen. In a cup, there is no change. The sachet containing the composition 184-51 is a little swollen but the composition remains in powder form. In a cup, the powder has become granular. The composition 184-52 forms a block whether it is stored in a cup or in a sachet. The same applies for 184-53. Finally, the composition 184-54 stored in a sachet remains in loose powder form; the sachet is not swollen and the perfume is still detectable to the nose in the powder and in the bowl after use. On the other hand, stored in a cup, the powder becomes granular and odorless.

After two months, only the compositions 184-51, 184-52 and 184-53, whether they be stored in a sachet or in a cup, are compacted and form a block or have become granular.

It appears that storage in a sachet is preferable, in particular for the compositions 184-48, 184-50 and 184-54. The sachet makes it possible to store a loose powder, probably since the powder spreads in the sachet and forms a thin layer that is not compacted/compressed by its own weight. In the cup, on the other hand, the surface with the external environment is limited (the cups are not closed) but the weight of the composition has a tendency to agglomerate despite the presence of silica.

### Influence of the Perfume

The marine perfume, the composition of which is unknown, completely destabilized the composition and/or is no longer detectable to the nose after two months of storage.

On the other hand, the pine fragrance, which contains at least one compound selected from alpha-cedrene epoxide, bornyl acetate, 8-sec-butylquinoline, 2,4,6-triethylcyclohex-3-ene-1-carbaldehyde, decaline, dibutylamine, synthetic amber, 1,1-dimethoxy-2-phenyl propane, methyl isonicotinate, nootkatone, 1-octen-3-ol, isophorone (low and high concentration), isopropyl quinolone, argeol and gamma-undecalactone makes it possible to obtain a fragrance that masks the nauseating odors likely to appear during and after defecation. The mixtures of at least two of these compounds can also be used as a fragrance.

1-11. (canceled)

12. A foaming composition in a form of a loose powder, comprising a sodium alginate and a foaming agent that comprises a mixture of at least one acid and at least one base, at a mass percentage of the mixture equal to or greater 90%, the mixture being reactable in presence of water by producing carbon dioxide, the foaming composition further comprising an anionic surfactant, wherein the anionic surfactant is an alkylbenzene sulfonate wherein an alkyl chain is linear and wherein the composition produces a layer of foam when it is dissolved in the water of a toilet bowl, said foam being configured to mask a noise of dropping of an excrement.

13. The composition of claim 12, wherein said foaming composition comprises a mass percentage of the anionic surfactant equal to or greater than 3% and equal to or less than 4%.

14. The composition of claim 13, wherein said foaming composition comprises a mass percentage of the anionic surfactant less than 3.5%.

15. The composition of claim 12, wherein said foaming composition comprises a mass percentage of the anionic surfactant is equal to or less than 1.5%.

16. The composition of claim 12, wherein the foaming agent mixture consists of citric acid, sulfamic acid and sodium bicarbonate, and wherein a mass percentage of citric acid is greater than a mass percentage of sulfamic acid.

17. The composition of claim 16, wherein the sodium bicarbonate has a mean diameter less than or equal to 130 μm.

18. The composition of claim 12, further comprising a thickener selected among guar gum, starch, pectin, agar-agar, gelatin, carrageenan and sodium alginates.

19. The composition of claim 18, wherein the mass percentage of the thickener is less than 2.00%.

20. The composition of claim 19, wherein the mass percentage of the thickener is equal to 1.60%.

21. The composition of claim 12, further comprising silica in a powder form, said silica having a surface measured in accordance with a BET method equal to or greater than 420 m²/g.

22. The composition of claim 21, wherein a mass percentage of said silica is between 0.08 and 0.3%.

23. The composition of claim 21, wherein a mass percentage of said silica is between 0.26% and 0.51%.

24. The composition of claim 12, further comprising a synthetic perfume excluding essential oils.

25. A flexible water-tight and airtight sachet comprising the composition of claim 12.
